(19) United States
(12) Patent Application Publication
(10) Pub. No.: US 2022/0121173 A1
(43) Pub. Date: Apr. 21, 2022

(54) METHOD AND SYSTEM FOR COMPUTER-AIDED MANUFACTURING OF A THREE-DIMENSIONAL PART

(71) Applicant: VIACCESS, COURBEVOIE (FR)

(72) Inventor: Pérez PELAGE, MEDAN (FR)

(21) Appl. No.: 17/310,447

(22) PCT Filed: Feb. 7, 2020
(86) PCT No.: PCT/EP2020/053137

§ 371 Date: Aug. 3, 2021

(30) Foreign Application Priority Data
Feb. 7, 2019 (FR) 19 01209

(51) Int. Cl. G05B 19/4099

(52) U.S. Cl. CPC G05B 19/4099; G05B 2219/49023

(57) ABSTRACT

The invention relates to a method and system for computer-aided manufacturing (2) of a three-dimensional part by a manufacturing device, and an associated method and system for complete or partial remanufacturing (4), using at least one predetermined manufacturing material, and implementing a set of manufacturing data. The manufacturing system (2) comprises modules (14, 18, 22, 6) configured to implement, during or at the end of the manufacturing of a three-dimensional part:
a calculation of a piece of remanufacturing information associated with said three-dimensional part, and comprising or allowing access to the set of data for manufacturing said three-dimensional part,
an inscription on the surface or in the body of said three-dimensional part, by a predetermined marking method, of a remanufacturing mark coding said remanufacturing information.

The remanufacturing system comprises modules (32, 36, 40, 46, 48) configured to implement a reading of the remanufacturing mark, obtaining of a set of manufacturing data of the initial three-dimensional part and a complete or partial remanufacturing of a three-dimensional part mechanically identical to said initial three-dimensional part.

The present invention relates to a method and system for computer-aided manufacturing of a three-dimensional part, and to an associated method and system for computer-aided remanufacturing thereof.

The invention is in the field of computer-aided manufacturing of three-dimensional parts, and in particular in the field of repair or replacement of such parts.

In the field of computer-aided manufacturing there is additive manufacturing on the one hand, for example three-dimensional printing, which consists of manufacturing a part by depositing successive layers of one or more predetermined materials, and subtractive manufacturing on the other hand, in which a three-dimensional part is manufactured by removing material from a block of material, for example by machining, plastic injection (or injection molding), or assembly. The invention applies to all of these fields and methods.

In all cases, the computer-aided manufacturing is carried out on the basis of a set of manufacturing data comprising a three-dimensional model obtained by computer-aided design and represented in a predetermined file format on the one hand, and, on the other hand, parameters relating to the manufacturing method and device, parameters relating to the materials used, and configuration parameters of the device for manufacturing the part.

In the case of additive manufacturing, and more precisely of three-dimensional printing, the manufacturing method designates the technique used to form a layer of material. For example, it can be Selective Laser Melting (SLM), in which a laser beam is directed towards a previously deposited powder bed, or Directed Energy Deposition (DED), in which a laser beam is directed towards a jet of material to melt it as it is deposited. Other methods are known, and the invention applies in their contexts. For each of these methods, corresponding parameters are to be set.

The manufacturing data contribute to the final properties of the manufactured object, and thus to compliance with a specification of the part to be manufactured. This manufacturing data is developed by the manufacturer of a three-dimensional part, and the development thereof requires the implementation of specific technical expertise.

Computer-aided manufacturing also comprises the creation and storage of a manufacturing report. The latter contains data characteristic of the actual conditions of the manufacturing of a part, obtained by sensors fitted to the manufacturing device.

In the case of additive manufacturing, the manufacturing report typically comprises one report per layer, which may for example contain a melting temperature, an evaluation of the homogeneity of the melting of the material used, and an image, obtained by means of thermal, acoustic or ultrasonic sensors, and an infrared camera.

In various practical scenarios, for example in the case of partial wear or damage of a three-dimensional part, an operator of the part, usually different from the manufacturer, needs to replace the existing part.

A classic solution is to make a request to the manufacturer of the original part, who is able to remanufacture and return a replacement part. In a variant, managing a stock of replacement parts is also known. Both of these conventional solutions have disadvantages, in terms of manufacturing time or difficulty in managing large stocks of replacement parts.

Alternatively, it is possible to have a replacement part remanufactured by a maintenance agent, distinct from the manufacturer of the initial part, when such an agent has adequate manufacturing devices. These manufacturing devices, called remanufacturing devices, are specifically constrained, and do not allow the maintenance agent to freely carry out all the parameterization. Moreover, the maintenance agent is not authorized to carry out computer-aided manufacturing operations upstream or downstream, such as the pre-processing phases of a three-dimensional model of a part to be manufactured, or the finishing of a manufactured three-dimensional part. The maintenance agent is previously certified by the manufacturer. A Digital Rights Management (DRM) system, or an access control system of any other type, can be used to control this authorization. Such a maintenance agent may, for example, be located advantageously in the geographical vicinity of the operating location of the three-dimensional part to be replaced.

One of the objects of the invention is to facilitate the repair or remanufacturing of three-dimensional parts by a maintenance agent different from the manufacturer.

To this end, the invention provides a method for computer-aided manufacturing of a three-dimensional part by a manufacturing device, using at least one predetermined manufacturing material, and implementing a set of manufacturing data comprising data relating to the shape of the three-dimensional part and corresponding commands operable by the manufacturing device to implement a predetermined manufacturing method, data relating to the manufacturing materials, and data relating to the device and the manufacturing method. This method, during or at the end of the manufacturing of a three-dimensional part, comprises steps of:
calculation of a piece of remanufacturing information associated with the said three-dimensional part, and comprising or allowing access to all the manufacturing data of the said three-dimensional part,
inscription on the surface or in the body of said three-dimensional part, by a predetermined marking method, of a remanufacturing mark, coding said remanufacturing information.

Advantageously, the method of the invention makes it possible to facilitate and automate a partial or complete remanufacturing of an initial three-dimensional part thanks to the inscription, on the surface or in the body of the initial three-dimensional part, of a mark encoding remanufacturing information making it possible to remanufacture, by a maintenance agent different from the initial manufacturer, a three-dimensional part that is mechanically identical to the initial three-dimensional part.

The three-dimensional part manufacturing method according to the invention may have one or more of the following features, taken independently or in any acceptable combination.

The calculation of a piece of remanufacturing information comprises:
calculation of a unique identifier of said three-dimensional part, and
application of a cryptographic combination of the unique identifier of the part and data from the set of manufacturing data.

The calculation of a unique identifier of said three-dimensional part comprises calculation of a physically unclonable function of at least a portion of the three-dimensional part to obtain a value of a physical unclonable characteristic of said at least a portion of the three-dimensional part.

The calculation of a unique identifier further comprises applying a cryptographic function to said physical characteristic value to obtain the unique identifier.

The application of said cryptographic combination comprises: concatenating the data from the set of manufacturing data, and applying a secret key cryptographic function, the secret key used for said function being said unique identifier.

The method further comprises a step of compressing at least a portion of the manufacturing data.

The marking is performed by printing a coded representation of said remanufacturing information.

At least a subset of the set of manufacturing data is replaced with a network address of a file containing said subset of the set of manufacturing data.

According to another aspect, the invention relates to a method for complete or partial remanufacturing, by a remanufacturing device, of a marked initial three-dimensional part manufactured by a manufacturing method as briefly described above. The remanufacturing method comprises steps of:
reading the mark inscribed on the surface or in the body of said three-dimensional part,
obtaining a set of manufacturing data of the original three-dimensional part from the piece of remanufacturing information obtained,
complete remanufacturing of a three-dimensional part, mechanically identical to said initial three-dimensional part, by the remanufacturing device, or partial remanufacturing of a part of said initial three-dimensional part using data from the set of manufacturing data obtained.

The method for remanufacturing a three-dimensional part according to the invention may have one or more of the following features, taken independently or in any acceptable combination.

The remanufacturing device has associated configuration parameters, and the remanufacturing method further comprises a step of validating the compliance of the configuration parameters of the remanufacturing device to the set of manufacturing data obtained.

Obtaining a set of manufacturing data set of the initial three-dimensional part comprises:
calculation of a unique identifier of said initial three-dimensional part,
application of a cryptographic recombination combining said unique identifier and the piece of remanufacturing information obtained.

The calculation of a unique identifier of the initial three-dimensional part comprises calculation of a physically unclonable function of at least a portion of the three-dimensional part, to obtain a unclonable physical characteristic value of said at least a portion of the initial three-dimensional part.

The cryptographic recombination comprises applying a second secret key cryptographic function, associated with the secret key cryptographic function applied at the time of the initial three-dimensional part, to the remanufacturing information obtained, the secret key used for said application being said unique identifier, and applying de-concatenation to the result of the decryption, to obtain manufacturing data.

According to another aspect, the invention relates to a manufacturing system for computer-aided manufacturing of a three-dimensional part by a manufacturing device, using at least one predetermined manufacturing material, and implementing a set of manufacturing data comprising data relating to the shape of the three-dimensional part and corresponding commands to implement a predetermined manufacturing method, operable by the manufacturing device, data relating to the manufacturing materials, and data relating to the manufacturing device and method. This system comprises modules configured to implement, during or at the end of the manufacturing of a three-dimensional part:
a calculation of a piece of remanufacturing information, associated with said three-dimensional part, and comprising or allowing access to all the manufacturing data of said three-dimensional part,
an inscription of a remanufacturing mark on the surface or in the body of said three-dimensional part, by a predetermined marking method, coding said remanufacturing information.

According to another aspect, the invention relates to a remanufacturing system for complete or partial remanufacturing, by a remanufacturing device, of a marked initial three-dimensional part manufactured by a manufacturing system as briefly described above, comprising modules configured to:
read the mark inscribed on the surface or in the body of said initial three-dimensional part,
obtain a set of manufacturing data for the initial three-dimensional part from the remanufacturing information obtained
completely remanufacture a three-dimensional part mechanically identical to said initial three-dimensional part by the remanufacturing device or partially remanufacture a portion of said initial three-dimensional part using data from the set of manufacturing data obtained.

Further features and advantages of the invention will be apparent from the description below, given by way of indication and not in any way limiting, with reference to the appended figures, of which:

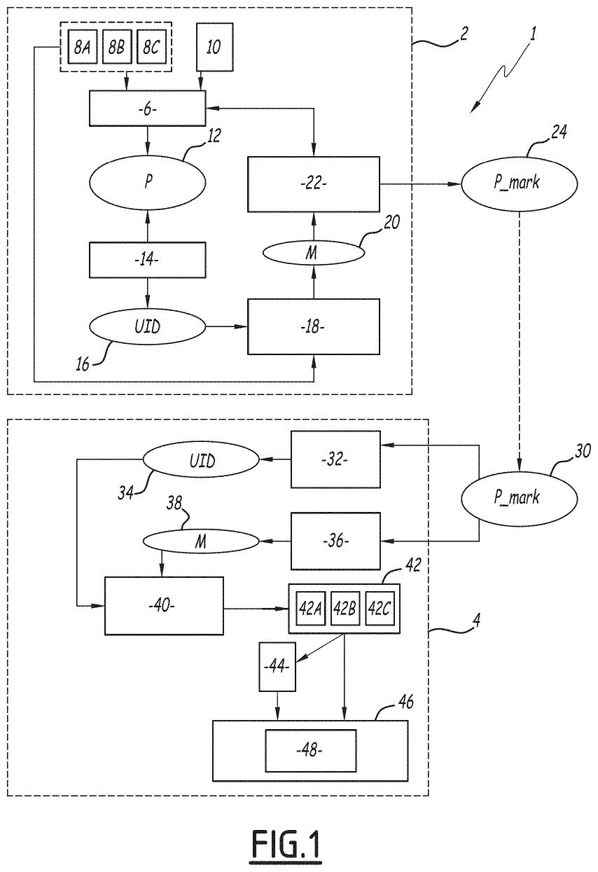

FIG. 1 schematically illustrates a system for manufacturing and remanufacturing a three-dimensional part according to one embodiment of the invention;

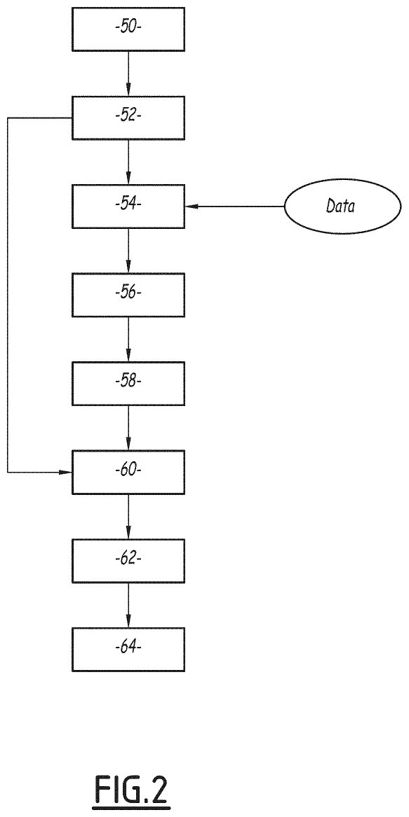

FIG. 2 is a flowchart of the main steps of a method for manufacturing a three-dimensional part according to a first embodiment of the invention;

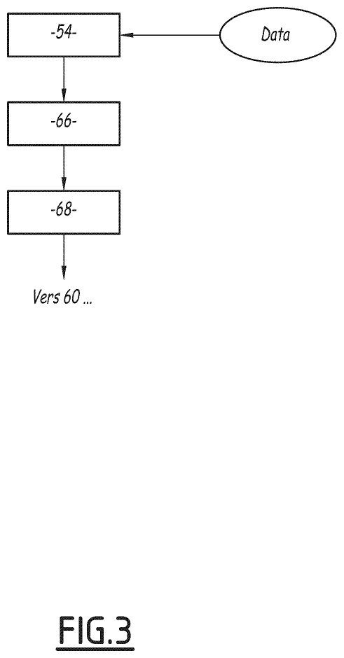

FIG. 3 is a flowchart of steps of a variant of the three-dimensional part manufacturing method;

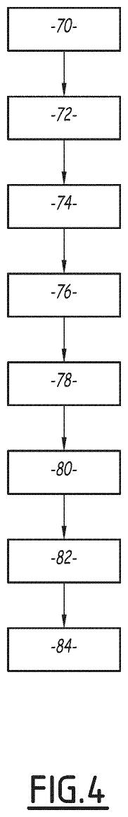

FIG. 4 is a flowchart of the main steps of a method for remanufacturing a three-dimensional part according to an embodiment of the invention;

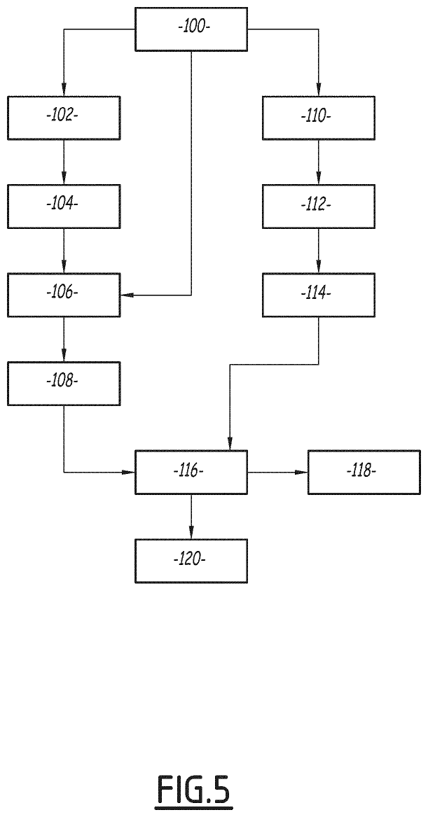

FIG. 5 is a flowchart of the main steps of implementing a remanufacturing using manufacturing data extracted from a marked three-dimensional part.

FIG. 1 schematically illustrates a system for manufacturing and remanufacturing a three-dimensional part according to an embodiment of the invention.

In this embodiment, the system 1 comprises a first subsystem 2 for manufacturing a three-dimensional part marked with a remanufacturing mark, and a second subsystem 4 for remanufacturing a three-dimensional part from a marked three-dimensional part, either completely or partially.

In an application scenario, the first subsystem 2 and the second subsystem 4 are located in geographically distant locations and are operated in different environments by operators of different professions.

For example, the first subsystem 2 is integrated into a manufacturing environment operated by a manufacturer and further typically comprising a methods office, responsible for pre-processing operations of a three-dimensional model of a part to be manufactured, and a post-processing shop, responsible for finishing operations of a manufactured part. The second subsystem 4 is, for example, isolated in an environment operated by a three-dimensional parts maintenance agent not authorized to perform some of the computer-aided manufacturing operations, in particular the phases of pre-processing a three-dimensional model of a part to be manufactured, or finishing a manufactured three-dimensional part.

The first subsystem 2 comprises a device 6 for manufacturing three-dimensional parts, for example a computer-aided additive manufacturing device such as a three-dimensional printer.

The device 6 is controlled in accordance with a set 8 of manufacturing data, and uses materials 10 to make a three-dimensional part P, reference 12 in FIG. 1.

The set of manufacturing data 8 comprises:
data 8A relating to the shape of the part to be manufactured, for example a model defining the shape of the three-dimensional part to be manufactured and corresponding commands operable by the manufacturing device to implement a predetermined manufacturing method,
data 8B relating to the manufacturing materials,
data 8C relating to the manufacturing device and the manufacturing method, in particular a manufacturing device type identifier and configuration parameters of the manufacturing device.

In one embodiment, the set of manufacturing data 8 is stored in a file of predetermined format.

According to one embodiment, the data 8A, 8B, 8C are stored in separate files.

According to another embodiment, the data 8A, 8B, 8C are compressed by applying a compression method, and stored in compressed form.

When the compression is performed with loss of information, the compressed data is stored together with the uncompressed data.

According to another embodiment, only a portion of the data 8A, 8B, 8C is compressed.

The manufacturing data 8A, 8B, 8C is stored by the manufacturer on at least one non-volatile, computer-readable electronic storage medium, preferably on at least one server connected via a network to the manufacturing device, or to a computer configured to control the manufacturing device.

In one embodiment, the data 8A comprises a three-dimensional model of the three-dimensional part to be manufactured and corresponding commands usable by the manufacturing device to implement a predetermined manufacturing method.

In particular, in the case of additive manufacturing by layers, they comprise commands from the manufacturing device for each layer of material to be deposited.

Such a three-dimensional model is obtained in a known way from a CAD model describing the geometry of the three-dimensional part to be manufactured, and from manufacturing method parameters of the, for example during a preprocessing phase in the design office. For example, the data 8A are in an exchange format, such as IGES (“Initial Graphics Exchange Specification”), STEP (“Standard for Exchange of Product Model Data”), STL (“Stereolitography”), AMF (“Additive Manufacturing File Format”) or 3MF (“3D Manufacturing Format”).

In an alternative embodiment, the data 8A is formed from an electronic address, for example a network address, for storing a file comprising the three-dimensional model of the part to be manufactured and the corresponding commands that can be used by the manufacturing device to implement a predetermined manufacturing method.

The data 8B relating to the manufacturing materials comprises, for example, physical characteristics of the materials, for example the nature (polymer or metal), particle size, moisture and oxidation rate, melting temperature.

In an alternative embodiment, the data 8B is formed from an electronic address, for example a network address, for storing a file comprising the data relating to the manufacturing materials.

The data 8C relating to the device and manufacturing method comprises, for example, a manufacturing device type identifier, a manufacturing method identifier, and manufacturing device configuration parameters, as well as parameters relating to the manufacturing method.

For example, the configuration parameters are the parameters to be set for a device operation, that is, both physical parameters (e.g., physical characteristics of the laser beams), and environmental parameters (atmosphere, humidity, oxygen or radon level in the manufacturing chamber).

The data 8C also comprises data relating to the manufacturing method, for example relating to the positioning of the part, the support(s) to be used at the time of material deposition or the laser strategy (scanning direction, etc.) to be implemented for each layer to be manufactured.

In an alternative embodiment, the data 8C is formed from an electronic address, for example a network address, for storing a file comprising data relating to the device and the manufacturing method.

The manufactured three-dimensional part 12 is analyzed by a module 14 for calculating a unique identifier 16, also referred to as a UID for “Unique IDentifier”, of the part 12. Preferably, the identifier 16 is derived from a random physical characteristic of the three-dimensional part, also referred to as a “Physically Unclonable Function” of the part. Such an identifier is intrinsically linked to the manufactured part.

In one embodiment, the physically unclonable function is an intrinsic physical unclonable characteristic, such as a physical irregularity of the surface of the part observed at a predetermined level of detail, an electromagnetic particle orientation of the material making up the part, or a distribution of chemical molecules of the material making up the part observable by spectrometer. Because the physically unclonable function is not under the control of the manufacturer, it is unpredictable for any new part to be manufactured. The manufacturer cannot therefore manufacture a part that is identical in this respect, or therefore exactly identical to a first given part, that is, clone this first part. In this case, the module 14 comprises a suitable analysis device, for example a scanner, an electromagnetic radiation sensor, or a spectrometer.

In one embodiment, during additive manufacturing or plastic injection molding, the manufacturing of the part is modified to add such a random physical characteristic, for example by adding to a first manufacturing material, a second material having mechanical properties similar to those of the first material but including a random physical characteristic.

According to another variant, a piece of semiconductor material is inserted into the part during its manufacture, and the physically unclonable function is calculated from the conductivity of this semiconductor piece. The conductivity of the semiconductor material, which is related to the thermal agitation, impurities or different types of defects, is random.

The UID is preferably calculated from the value of the physically unclonable function of the three-dimensional part, for example by applying a hash function or symmetrical block chain encryption, that is, in CBC mode, for “Cipher Block Chaining”, or any other cryptographic function. This calculation enables keeping the value of the physically unclonable function of the part confidential, endowing the UID identifier with a predetermined length, and dispersing the UID identifiers of the three-dimensional parts in their value space. In a variant, the UID identifier is taken equal to the value of the physically unclonable function of the part.

The UID 16 obtained is provided to a computational module 18, configured to compute remanufacturing information 20. This module 18 also receives the set of manufacturing data 8 as input.

The calculation module 18 is implemented by a programmable electronic device, for example a computer, or an electronic device made in the form of programmable logic components, such as an FPGA (Field-Programmable Gate Array), or in the form of dedicated integrated circuits, of the ASIC (Application-Specific Integrated Circuit) type. This electronic device includes a central processing unit, or CPU, comprising one or more electronic processors, capable of executing computer program instructions when the electronic device is powered up. The calculation module 18 is made in the form of computer program code instructions, for example.

The module 18 is a computing module that, in one embodiment, performs a cryptographic combination of the UID 16 and the manufacturing data 8. This cryptographic combination is, for example, a cryptographic function parameterized by a secret key, also referred to as a secret key, the key used to be constituted by the UID 16.

For example, the manufacturing data 8A, 8B, 8C are concatenated into a character string, to which the cryptographic function parameterized by the UID 16 is then applied. For example, the character string is encrypted by a symmetric secret key encryption algorithm, the key used to be constituted by the UID 16. The result of this operation is the remanufacturing information 20. The UID 16 and the manufacturing data 8 are linked in the remanufacturing information 20, so that it is difficult to parse the latter to infer the former.

The three-dimensional part is then marked, using a marking module 22 implementing a predetermined marking method, with a mark encoding the remanufacturing information 20, hereinafter referred to as a remanufacturing mark, to output the three-dimensional part 24 marked with the remanufacturing mark.

The remanufacturing mark is, for example, the remanufacturing information 20 in alphanumeric format, or a QR-code encoding the remanufacturing information 20, or a barcode encoding the remanufacturing information 20, or any other representation of this information. The marking module 22 thus calculates the remanufacturing mark and then triggers or carries out the actual marking.

The effective marking is carried out by printing for example, on the surface of the three-dimensional part. In this case, for example, the marking module 22 comprises printing means for this purpose. In another example, when the part is manufactured by additive manufacturing, the marking module 22 transmits the remanufacturing mark to the manufacturing device 6 that prints it.

According to another variant, when the part is manufactured by additive manufacturing, the marking module 22 is adapted to interact with the manufacturing device 6 once the three-dimensional part 12 is partially manufactured. In this variant, the mark representative of the remanufacturing information can be inserted or inscribed in the body of the three-dimensional part being manufactured, that is, on an internal surface or in an internal volume of the part, outside of its previously manufactured part. It should be noted that in this case, the unique identifier calculation module 14 is applied to the partially manufactured three-dimensional part. It is then intended to use a physical characteristic of the manufactured part of the three-dimensional part that it will be possible to extract, also from the three-dimensional part when it is completely manufactured.

The device 6 and the modules 14, 18 and 22, are organized according to any viable architecture of the subsystem 2. For example, the modules 14, 18 and 22 are integrated with the device 6, or with a single second device of the subsystem 2.

The second subsystem 4 performs remanufacturing of three-dimensional parts that are mechanically identical to the three-dimensional parts manufactured by the manufacturer.

The term “mechanically identical” is understood here from the point of view of the manufacturer, the manufacturing method and the specifications to be met.

Two distinct parts, even if they belong to the same series manufactured by the same manufacturer and are identical from the point of view of the manufacturer and the manufacturing method, insofar as they meet the same specifications, are never exactly identical. For example, two parts of the same series of polished parts are equally smooth insofar as they meet the same requirement, for example, in terms of a maximum limit of surface irregularity. If, on the other hand, their surfaces are observed at a higher level of precision, for example ten or one hundred times, that is, at a level of precision not controlled by the manufacturer and the manufacturing method, then their irregularities are different, random and unpredictable before manufacturing.

The second subsystem 4 receives an initial three-dimensional part 30 as input, which may be partially worn or damaged, for remanufacturing a mechanically identical three-dimensional part.

The subsystem 4 comprises a module 32 for unique identifier calculation 34. The module 32 is analogous to the module 14 forming part of the first part manufacturing subsystem 2. It performs a calculation of the same physically unclonable function of the part as calculated by the module 14, and, if applicable, a unique identifier UID calculation, analogous to that performed by module the 14. An UID 34 is obtained.

The subsystem 4 comprises a mark reading module 36, adapted to read a mark inscribed on the surface or in the body of the three-dimensional part by the marking module 22 of the first subsystem 2, and allowing the remanufacturing mark to be decoded, to obtain the associated remanufacturing information. For example, when the marking module 22 performs QR-code printing, the module 36 includes an optical reader and an image processing module for obtaining remanufacturing information from the QR-code read and decoded. The mark reading module 36 provides remanufacturing information obtained 38.

The unique identifier 34 and the remanufacturing information 38, obtained from the original three-dimensional part, are provided to a computing module 40 that performs a cryptographic recombination of the unique identifier and the remanufacturing information, related to the cryptographic combination operation performed by the computing module 18, to obtain manufacturing data 42.

For example, this cryptographic recombination is a secret key cryptographic function associated with the cryptographic function applied by the module 18, the key used to be the unique identifier 34.

For example, if the module 18 performs a concatenation of the data 8A, 8B, 8C and a symmetric encryption, by a chosen symmetric encryption algorithm, whose secret key is the UID 16, the module 40 performs the corresponding decryption, with the UID 34 as secret key. A decrypted character string is then obtained. The module 40 performs de-concatenation to extract extracted manufacturing data, referenced 42A, 42B, 42C.

In the case where the manufacturing data has been compressed without loss of information, a corresponding decompression algorithm is applied.

In the case where the manufacturing data has been compressed with information loss, the uncompressed manufacturing data is obtained using the compressed manufacturing data that has been stored in association therewith.

The manufacturing data 42A, 42B, 42C is then evaluated to determine the materials 44 to be used by a remanufacturing system 46, including a remanufacturing device 48, such as a three-dimensional reprint printer.

The remanufacturing system 46 performs a compliance check of its set of configuration parameters to the obtained manufacturing data 42 before initiating the actual remanufacturing, as explained in detail below with reference to FIG. 5, in order to ensure the remanufacturing of a three-dimensional part that is mechanically identical to the initial three-dimensional part.

Indeed, in order to avoid possible attacks against the remanufacturing system, it is useful to ensure that authentic and intact manufacturing data of the initial three-dimensional part is obtained, and also to ensure that the actual remanufacturing is performed in accordance with such manufacturing data.

In one embodiment, the remanufacturing device 48 is analogous to the manufacturing device 6, but specifically constrained, and does not allow the maintenance person to freely perform all of the setup.

The devices 46, and 48, and the modules 32, 36 and 40 are organized according to any viable architecture of the subsystem 4. For example, the modules 32, 36 and 40 are integrated into the same third device of the subsystem 4, external or internal to the device 46, and, in the latter case, external or internal to the device 48.

FIG. 2 is a flowchart of the main steps for manufacturing a marked three-dimensional part according to a first embodiment of the invention.

The method comprises a step 50 of extracting, that is, calculating a value of a unclonable physical characteristic of the finished or in-method three-dimensional part, by calculating a physically unclonable function as described above with reference to FIG. 1.

A unique identifier of the three-dimensional part is obtained in step 52, for example, by applying a cryptographic hash function, or any other cryptographic function, to the feature value obtained by computing the physically unclonable function. Any known hash function, for example SHA-1, may be used. At the output of step 52, the unique identifier UID of the three-dimensional part is obtained.

According to a variant, step 52 is omitted, and the unique identifier of the part is the unclonable physical feature value obtained in step 50.

According to another embodiment, a unique identifier of the three-dimensional part is obtained by incrementing a serial number and/or generating a random or cryptographic key associated with the part.

A step 54 of receiving a set of manufacturing data (Data) is implemented. As already explained, the set of manufacturing data contains data relating to the shape of the part to be manufactured and corresponding commands operable by the manufacturing device to implement a predetermined manufacturing method, data relating to the manufacturing materials and data relating to the manufacturing device and method.

If the set of manufacturing data is large, compression of at least a portion of such data (step 56) is contemplated in this embodiment.

The compressed manufacturing data in this sense is concatenated in the concatenation step 58.

In one embodiment, the manufacturing data is first concatenated and then compressed.

In the case where lossy compression is performed, the compressed manufacturing data is stored in association with the uncompressed manufacturing data.

It should also be noted that steps 50 and 52 may be performed after steps 54 through 58, or substantially in parallel with those steps.

At the end of step 58, a string representative of the manufacturing data is obtained.

The unique identifier obtained in step 52 and the character string representative of the manufacturing data obtained in step 58 are provided as input to the cryptographic combination step 60.

For example, a symmetric secret key encryption algorithm, with the key used being the unique identifier calculated in step 52, is implemented to obtain remanufacturing information.

Any known encryption algorithm, for example AES (Advanced Encryption Standard), can be used in step 52.

A mark to be affixed to the surface or inserted into the body of the three-dimensional part is generated in step 62, based on the remanufacturing information. The mark is then inscribed onto the surface or into the body of the three-dimensional part (step 64) by a predetermined marking method.

For example, a QR-Code, which is a matrix of black and white pixels to encode the remanufacturing information, is created.

This QR-code is then printed on a surface of the part, internal or external, or in a volume of the part, in the marking step 64. The three-dimensional part marked with a mark encoding the remanufacturing information is then obtained.

Steps 52 through 62 are preferably implemented as software code that can be executed by a computer.

The compression step 56 is optional, according to a variant the manufacturing data is used without compression.

FIG. 3 is a synopsis of the main steps in an embodiment of the marked three-dimensional part manufacturing.

The embodiment of FIG. 3 differs from the embodiment of FIG. 2 in that steps 56 and 58 are replaced by steps 66 and 68, with the remaining steps remaining unchanged.

As in the first embodiment described with reference to FIG. 2, in the receiving step 54 a set of manufacturing data is received.

This data is for example presented in one or more files, having a predetermined file format.

In step 66 the file or files containing the manufacturing data are stored in a storage unit, either local or remote.

An address of the storage unit, for example a network address of the storage unit, allowing access to the file(s) storing the manufacturing data, is obtained in step 68.

In this embodiment, the network address for accessing the manufacturing data is the string provided as input to the cryptographic combining step 60.

The embodiments described with reference to FIGS. 2 and 3 can be combined, that is, implemented during the same manufacturing method for separate portions of the manufacturing data.

FIG. 4 is a flowchart of the main steps of a method for remanufacturing a three-dimensional part, completely or partially, from a three-dimensional part marked during its manufacture described above.

The embodiment shown in FIG. 4 corresponds to the first embodiment of the manufacturing method described above with reference to FIG. 2.

The method comprises a first step 70 of receiving an initial marked three-dimensional part to be repaired (partial remanufacturing) or remanufactured (complete remanufacturing).

A mark reading 72 is then applied. The mark reading step implements a reading method adapted to read a mark inscribed on the surface or in the body of the three-dimensional part by the marking method implemented in the marking step 64.

For example, when the marking step 64 implements QR-code printing, step 72 implements a QR-code scanner reading, and a character string extraction by image processing applied to the read QR-code.

Then a step 74 of extracting a unclonable physical feature of the received three-dimensional part, analogous to step 50 described with reference to FIG. 2, is implemented. Step 74 is followed by a step 76 of obtaining a unique identifier of the received part, analogous to step 52 described above.

Steps 74 and 76 may be implemented before steps 70 and 72, or substantially in parallel.

A cryptographic recombination step 78 associated with the combination performed in step 60 is then implemented, using the unique identifier obtained and the character string obtained in step 72.

In this embodiment, the cryptographic recombination consists in applying the decryption algorithm allowing to decrypt data encrypted by the encryption algorithm implemented in step 60, using the unique identifier obtained as the secret key.

At the end of the cryptographic recombination step 78, remanufacturing information extracted from the part is obtained.

In this embodiment, the remanufacturing information corresponds to compressed and concatenated manufacturing data during manufacturing.

The recombining step 78 is followed by a de-concatenation step 80, and then, when the manufacturing data has been compressed in a step 56, by a step 82 of obtaining the uncompressed manufacturing data, either by decompression or from the manufacturer using the compressed manufacturing data that he had stored in association with the uncompressed manufacturing data, depending on whether the compression had been performed without or with loss of information, respectively.

Manufacturing data, extracted from the initial marked three-dimensional part, is then obtained at the output of step 82, and temporarily stored in the storage step 84, for implementation of the actual remanufacturing. Preferably, the obtained manufacturing data are only stored for the implementation of the remanufacturing, so as to avoid any subsequent re-use by the maintenance agent.

In a second embodiment of the remanufacturing method, corresponding to the embodiment described above with reference to FIG. 3, the character string obtained from step 78 comprises at least one network address of at least a portion of the manufacturing data.

In the remanufacturing method described with reference to FIG. 4, in the event of an error in reading the mark or extracting from the received three-dimensional part a unclonable physical characteristic different from that extracted from it in step 50, the manufacturing data obtained is not usable as such. In this case, the remanufacturing is stopped.

FIG. 5 is a flowchart of the main steps of implementing a remanufacturing using manufacturing data obtained from an initial marked three-dimensional part according to a method as described above.

In this embodiment, the remanufacturing method comprises a first step 100 of receiving manufacturing data obtained by the method described with reference to FIG. 4.

In a step 102 an indication of the type of manufacturing device is extracted from the manufacturing data, and a remanufacturing device of the indicated type is selected in step 104. Additionally, a set of configuration parameters for the remanufacturing device is obtained in step 104.

In a variant, when the remanufacturing subsystem has only one remanufacturing device, the selection of a remanufacturing device is omitted.

In step 106 manufacturing data relating to the configuration of the manufacturing device is extracted from the manufacturing data obtained in step 100.

A compliance test of the set of remanufacturing device configuration parameters to the manufacturing data relating to the manufacturing device configuration obtained in step 106 is implemented in step 108, and the result of this compliance test, indicating compliance or noncompliance, is transmitted to a step 116 described below.

For example, as soon as the value of one piece of the configuration data of the remanufacturing device is different from that of the homologous obtained manufacturing data, its value is forced to eliminate this elementary noncompliance, if it can be, or an elementary noncompliance is found.

Compliance is only diagnosed at the end of the testing step 108 if no elementary non-compliance has been found.

A step 110 of obtaining manufacturing data relating to the manufacturing materials is also implemented, for example substantially in parallel with step 102.

Materials identified in this manner are obtained locally (step 112) by selection, and a compliance test between the properties of the locally obtained materials and the manufacturing data relating to the materials is implemented in step 114.

Similar to the compliance test in step 108, the compliance test in step 114 transmits a compliance or non-compliance result to step 116.

At step 116, the results of the compliance tests are compiled, and if non-compliance is found, remanufacturing does not take place (stop step 118).

Advantageously, this avoids remanufacturing a part that does not comply with the specifications it is supposed to meet.

If no non-compliance has been detected, the actual data of the remanufacturing subsystem, known as remanufacturing data, is considered to comply with the manufacturing data obtained from the marked three-dimensional part, and step 116 is followed by a step 120 of actually remanufacturing a new three-dimensional part, in accordance with the obtained manufacturing data, that is mechanically identical to the marked three-dimensional part received.

In one embodiment, step 120 implements a remanufacturing of the three-dimensional part without marking.

According to one embodiment, step 120 implements a remanufacturing of three-dimensional part with marking, that is, implements the manufacturing method steps described above.

According to another variant, step 120 implements a partial remanufacturing, or, in other words, a repair of the initial three-dimensional part. In this case, the initial three-dimensional part received in step 70 described above as input to the method, is supplemented with a missing part portion.

The invention also applies in the case of subtractive manufacturing. In this case, the marking performed in the marking step 64 is performed on an outer surface of the part.

In the case where the manufacturing is additionally carried out by plastic injection, the manufacturing device comprises in particular an injection mold of suitable size. Such an injection mold is either obtained by means of a mold or mold type identifier included in the manufacturing data, or is remanufactured according to the manufacturing data relating to the shape of the three-dimensional part. In particular, the three-dimensional model of the part is used for this purpose.

Advantageously, the invention enables a three-dimensional part to be remanufactured from an initial three-dimensional part, the remanufactured three-dimensional part being mechanically identical to the initial three-dimensional part in a new state. Thus, the invention facilitates the performance of maintenance of three-dimensional parts. In particular, the invention facilitates remanufacturing by a maintenance agent at the request of a manufacturer, and thus allows it to be substituted in spare parts inventory management.

1. A method of computer-aided manufacturing of a three-dimensional part by a manufacturing device, using at least one predetermined manufacturing material, and implementing a set of manufacturing data comprising data relating to the shape of the three-dimensional part and corresponding commands that can be used by the manufacturing device to implement a predetermined manufacturing method, data relating to the manufacturing materials, and data relating to the device and to the manufacturing method, comprising, during or at the end of the manufacturing of a three-dimensional part:
a calculation of a piece of remanufacturing information, associated with the three-dimensional part, and comprising or allowing access to all the manufacturing data of the three-dimensional part,
an inscription on the surface or in the body of three-dimensional part, by a predetermined marking method, of a remanufacturing mark, coding the remanufacturing information.

2. The method according to claim 1, wherein the calculation of a piece of remanufacturing information comprises:
a calculation of a unique identifier of three-dimensional part, and
an application of a cryptographic combination combining the unique identifier of the part and data from the set of manufacturing data.

3. The method according to claim 2, wherein the calculation of a unique identifier of the three-dimensional part comprises the calculation of a physically unclonable function of at least a portion of the three-dimensional part to obtain a value of a unclonable physical characteristic of the at least a portion of the three-dimensional part.

4. The method according to claim 3, wherein the calculation of a unique identifier further comprises the application of a cryptographic function to the physical characteristic value to obtain the unique identifier.

5. The method according to claim 2 wherein the application of the cryptographic combination comprises: concatenation of the set of manufacturing data, and application of a secret key cryptographic function, the secret key used for said cryptographic function being the unique identifier.

6. The method according to claim 5, further comprising a step of compressing at least a portion of the manufacturing data.

7. The method according to claim 1, wherein the marking is performed by printing a coded representation of the remanufacturing information.

8. The method according to claim 1, wherein at least a subset of the set of manufacturing data is replaced with a network address of a file containing subset of the set of manufacturing data.

9. A method of complete or partial remanufacturing, by a remanufacturing device, of a marked initial three-dimensional part manufactured by a manufacturing method according to claim 1, comprising steps of:
reading the mark inscribed on the surface or in the body of the initial three-dimensional part,
obtaining a set of manufacturing data of the initial three-dimensional part from the remanufacturing information obtained,
completely remanufacturing a three-dimensional part by the remanufacturing device, mechanically identical to the initial three-dimensional part or partially remanufacturing a portion of the initial three-dimensional part using data from the set of manufacturing data obtained.

10. The method according to claim 9, wherein the remanufacturing device has associated configuration parameters, and further comprising a conformity validation of the configuration parameters of the remanufacturing device to the set of manufacturing data obtained.

11. The method according to claim 9, wherein obtaining a set of manufacturing data of the initial three-dimensional part comprises:
a calculation of a unique identifier of the initial three-dimensional part,
an application of cryptographic recombination combining the unique identifier and the remanufacturing information obtained.

12. The method according to claim 11, wherein the calculation of a unique identifier of the initial three-dimensional part comprises the calculation of a physically unclonable function of at least a portion of the three-dimensional part to obtain a unclonable physical characteristic value of the at least a portion of the initial three-dimensional part.

13. The method according to claim 11, wherein the cryptographic re-combining comprises the application of a second secret key cryptographic function, associated with the secret key cryptographic function applied to the remanufacturing information obtained under the manufacturing method according to claim 1 of the initial three-dimensional part, the secret key used for said application being the unique identifier, and the application of a de-concatenation to the decryption result to obtain manufacturing data.

14. A system for computer-aided manufacturing of a three-dimensional part by a manufacturing device, using at least one predetermined manufacturing material, and implementing a set of manufacturing data comprising data relating to the shape of the three-dimensional part and corresponding commands operable by the manufacturing device to implement a predetermined manufacturing method, data relating to the manufacturing materials and data relating to the manufacturing device and method, comprising modules configured to implement, during or at the end of the manufacturing of a three-dimensional part
a calculation of a piece of remanufacturing information, associated with the three-dimensional part, and comprising or allowing access to all the manufacturing data of the three-dimensional part,
an inscription on the surface or in the body of the three-dimensional part, by a predetermined marking method, of a remanufacturing mark coding the remanufacturing information.

15. The system for complete or partial remanufacturing, by a remanufacturing device, of a marked initial three-dimensional part manufactured by a manufacturing system according to claim 14, comprising modules configured to implement:
reading of the mark inscribed on the surface or in the body of the initial three-dimensional part,
obtaining a set of manufacturing data of the initial three-dimensional part from the remanufacturing information obtained
completely remanufacturing a three-dimensional part by the remanufacturing device, mechanically identical to the initial three-dimensional part or partially remanufacturing a part of the initial three-dimensional part using data from the set of manufacturing data obtained.
